(19) United States
(12) Patent Application Publication
(10) Pub. No.: US 2013/0327757 A1
(43) Pub. Date: Dec. 12, 2013

(54) HEATING ELEMENT AND METHOD FOR MANUFACTURING SAME

(71) Applicants: Su-Jin Kim, Daejeon (KR); Young-Jun Hong, Daejeon (KR); Hyeon Choi, Daejeon (KR); Ki-Hwan Kim, Daejeon (KR)

(72) Inventors: Su-Jin Kim, Daejeon (KR); Young-Jun Hong, Daejeon (KR); Hyeon Choi, Daejeon (KR); Ki-Hwan Kim, Daejeon (KR)

(73) Assignee: LG CHEM, LTD., Seoul (KR)

(21) Appl. No.: 13/941,181

(22) PCT Filed: Jan. 13, 2012
(86) PCT No.: PCT/KR2012/000324

§ 371 Date: Jul. 12, 2013

(30) Foreign Application Priority Data
Jan. 13, 2011 (KR) 10-2011-0003474

(51) Int. Cl. H05B 3/86; B05D 5/12

(52) U.S. Cl. CPC H05B 3/86; B05D 5/12
USPC 219/203; 219/538; 219/213; 427/108; 156/60

(57) ABSTRACT

The present invention relates to a heating element in which distortion of a view due to local heating around a heating line does not occur even when a heating value is high, and a method for manufacturing the same. More specifically, the heating element according to the present invention comprises a transparent substrate and conductive heating lines provided on the transparent substrate, in which a line width of the conductive heating line is 10 μm or less and a distance between the conductive heating lines is 500 μm or less.

### TECHNICAL FIELD

The application claims priority from Korean Patent Application No. 10-2011-0003474, filed on Jan. 13, 2011 with the Korean Patent Office, the disclosure of which is incorporated herein in its entirety by reference.

The present invention relates to a heating element and a method for manufacturing the same. More particularly, the present invention relates to a heating element that reduces the occurrence of distortion of a view during heating, and a method for preparing the same.

### BACKGROUND ART

Frost on vehicle windows occurs due to a temperature difference between the outside and the inside of the vehicle during the winter or on a rainy day. Further, dew condensation occurs due to a temperature difference between the inside and the outside of an indoor ski resort having a slope. In order to solve the problems, heating glass has been developed. The heating glass uses a concept of generating heat from a heat line by applying electricity to both ends of the heat line after attaching a heat line sheet to the glass surface or directly forming the heat line on the glass surface to increase a temperature of the glass surface.

It is important for the heating glass for a vehicle or a building to have low resistance in order to smoothly generate the heat while at the same time, the aesthetics of the heating glass should be taken into consideration. For this reason, methods of preparing a known transparent heating glass by forming a heating layer through a sputtering process of a transparent conductive material such as indium tin oxide (ITO) or Ag thin film and then connecting an electrode to a front end have been proposed. However, it was difficult to drive the heating glass prepared by these methods at a low voltage of 40 V or less due to high surface resistance.

Accordingly, for heating at the voltage of 40 V or less, a method using a metal line should be used. However, when the metal line is used, an optical characteristic is deteriorated due to opacity of metal and thus compensation therefor is required. To this end, a method of maintaining a distance of 1 mm or more between metal lines while maintaining a line width of a pattern of 50 μm or less is being used.

Meanwhile, as for a heating element using the metal lines as described above, a method of adhering a film such as PVB to a portion with the metal lines is being used.

### DETAILED DESCRIPTION OF THE INVENTION

### Technical Problem

The present inventors found out that a heating element using a conductive heating line such as a metal line not a planar heating element has a problem in that a distance between heating lines is wide and when a film such as PVB is adhered on the heating lines, an image shimmers due to local heating around the heating lines when a heating value is 200 W/m² or more. Therefore, the present invention has been made in an effort to solve distortion of a view occurring during heating of a heating element based on the problem.

### Technical Solution

An exemplary embodiment of the present invention provides a heating element, comprising: a transparent substrate; and conductive heating lines provided on the transparent substrate, in which a line width of the conductive heating line is 10 μm or less and a distance between the conductive heating lines is 500 μm or less.

The heating element may further comprise an additional transparent substrate on a surface with the conductive heating lines.

Another exemplary embodiment of the present invention provides a method of manufacturing a heating element, comprising: forming conductive heating lines having a line width of 10 μm or less and a distance of 500 μm or less between lines on a transparent substrate.

The method may further comprise adhering an additional transparent substrate on a surface with the conductive heating lines.

### Advantageous Effects

According to the exemplary embodiments of the present invention, it is possible to provide excellent optical characteristics without optical interference without obstructing a field of vision even when a conductive heating line is made of an opaque material such as metal and to prevent distortion of a view in which an image shimmers due to local heating around the conductive heating lines even when the heating value is 200 W/m² or more, by controlling the line width and the distance between lines of the conductive heating lines of the heating element.

### BRIEF DESCRIPTION OF DRAWINGS

FIG. 1 is a photograph illustrating a result of testing for distortion of a view of heating elements manufactured in Examples 1 and 2 of the present invention.

FIG. 2 is a photograph illustrating a result of testing for distortion of a view of heating elements manufactured in Comparative Examples 1 and 2 of the present invention.

FIG. 3 is a diagram schematically illustrating a tester for a perspective transformation test of a heating element according to an exemplary embodiment of the present invention.

FIG. 4 is a diagram illustrating an exemplary embodiment of a pattern applied to a slide of FIG. 3.

### BEST MODE

Hereinafter, the present invention will be described in detail.

A heating element according to the present invention comprises a transparent substrate; and conductive heating lines provided on the transparent substrate, in which a line width of the conductive heating line is 10 μm or less and a distance between the conductive heating lines is 500 μm or less.

The present invention is based on the fact that a heating element comprising a conductive heating line not a planar heating element can prevent a field of vision from being obstructed even when the conductive heating line is made of an opaque material such as metal and prevent distortion of a view due to local heating around the conductive heating lines, by controlling the line width and the distance between lines of the conductive heating lines within a predetermined range.

In the present invention, the line width of the conductive heating line may be 10 μm or less and 0.5 to 8 μm. The distance between the conductive heating lines may be 500 μm or less, 1 to 300 μm, and 10 to 300 μm.

The distortion of a view may not occur at a heating level of 100 to 200 W/m² even in a known heating element having a distance of 2 mm between lines, but distortion of an image occurs at a heating level of 200 W/m² or more. However, in the present invention, it is possible to prevent the distortion of a view of the heating element by controlling a line width and a distance between lines within a predetermined range as described above.

Further, in the present invention, it is possible to improve optical characteristics by controlling the line width as well as the distance between lines. First, even when increasing the density of heating lines in order to obtain a desired heating value by controlling the line width to be 10 pm or less, the heating lines are not visible and thus it is possible to achieve an effect of not obstructing a field of vision. Further, optical interference may occur according to a relationship between the line width and the distance between the lines and in the present invention, it is possible to prevent the optical interference by controlling the distance between lines to be 500 μm or less and simultaneously controlling the line width to be 10 μm or less. In the present invention, when controlling the distance between lines to be 300 μm or less, particularly, approximately 300 μm, the controlling of the line width to be 8 μm or less is advantageous for preventing optical interference.

In the present invention, a line height of the conductive heating line may be 20 μm or less, 0.5 to 20 μm, and 1 to 10 μm.

In the present invention, the transparent substrate is not particularly limited, but light transmittance thereof may be 50% or more and 75% or more. Specifically, as the transparent substrate, glass may be used and a plastic substrate or a plastic film may be used. In the case of using the plastic film, after forming a conductive heating line pattern, glass may be attached to at least one surface of the substrate. In this case, the glass or the plastic substrate may be attached to the surface with a conductive heating line pattern of the transparent substrate. As the plastic substrate or film, a material known in the art may be used, and for example, may be a film having visible-light transmittance of 80% or more such as polyethylene terephthalate (PET), polyvinylbutyral (PVB), polyethylene naphthalate (PEN), polyethersulfon (PES), polycarbonate (PC), and acetyl celluloid. A thickness of the plastic film may be 12.5 to 500 μm and 50 to 250 μm.

In the present invention, a transformed degree by a perspective transformation test of the heating element may be 10% or less and 5% or less when a heating value is 200 to 1,000 W/m². When the transformed degree by the perspective transformation test exceeds 10% at the heating value of 200 to 1,000 W/m², distortion of a view in which an image shimmers due to local heating around the heating lines may occur.

In general, a perspective transformation test for safety glasses for road vehicles (KS L 2007) is known to those skilled in the art as a test for examining a perspective transformation state of a safety glass used for a windscreen for a vehicle. The present inventors modified and applied the perspective transformation test to a test for evaluating distortion of a view of the heating element and found out that when the transformed degree by the perspective transformation test of the heating element is 10% or less at the heating value of 200 to 1,000 W/m², it is possible to suppress the distortion of a view in which an image shimmers due to local heating around the heating lines.

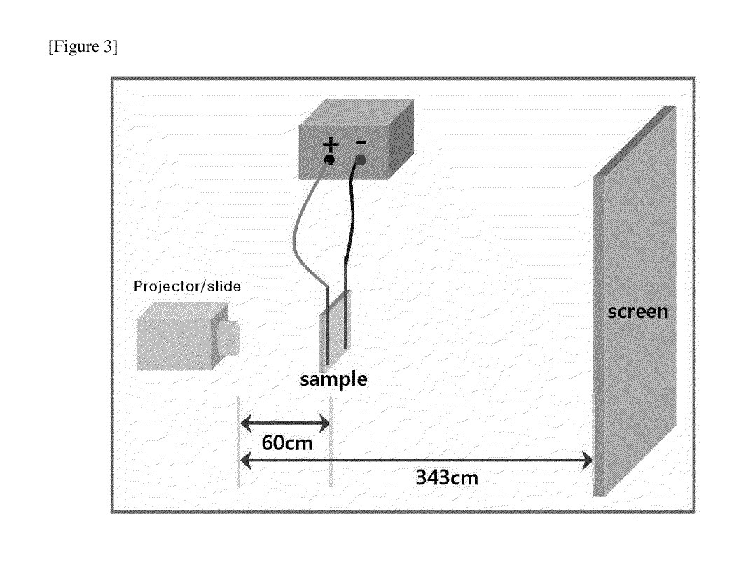

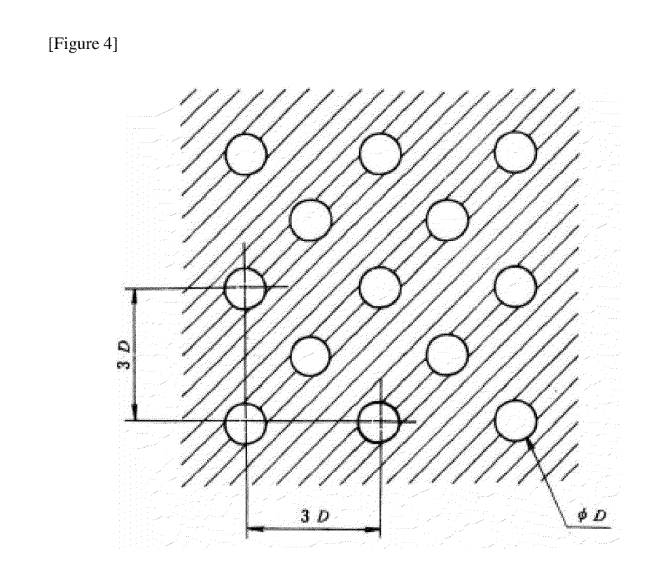

More specifically, the perspective transformation test of the heating element according to the present invention may be performed by using a tester shown in FIG. 3. The distortion of a view of the heating element may be evaluated by mounting and projecting, on a slide of FIG. 3, a heating element to be measured using a pattern as shown in FIG. 4, and then measuring a transformed degree of a diameter of a circle of FIG. 4 projected on a screen. D of FIG. 4 denotes a diameter (mm) of a circle. That is, the transformed degree of the heating element may be calculated by the following Equation 1.

Transformed degree (%)=(D2−D1)/D1×100 [Equation 1]

In Equation 1, D1 denotes a diameter (mm) of a circle of FIG. 4 projected on the screen before mounting the heating element on a tester for the perspective transformation test and D2 denotes a diameter (mm) of a circle of FIG. 4 projected on the screen after mounting the heating element on the tester for the perspective transformation test.

In the present invention, a projector of FIG. 3 may use a lamp of 150 W as a light source and use a focal distance of an object lens of 85 mm. The slide of FIG. 3 may use a slide comprising the pattern of FIG. 4. The diameter (D) of the circle of FIG. 4 is 0.165 mm and the diameter of the circle projected on the screen before mounting the heating element as a sample of which the transformed degree is to be measured was 7 mm. That is, the perspective transformation test of the heating element according to the present invention uses the tester of FIG. 3 and the slide comprising the pattern of FIG. 4 as the slide of FIG. 3 and may be performed by measuring the transformed degree of the diameter of the circle projected on the screen before and after mounting the heating element as a sample of which the transformed degree is to be measured by using the aforementioned Equation 1.

The heating element of the related art has a problem in that an image shimmers due to local heating around heating lines even when a heating value is 200 W/m² or more, but the heating element according to the present invention can suppress the distortion of a view in which an image shimmers due to local heating around heating lines even when a heating value is 200 to 1,000 W/m² by comprising the conductive heating lines having the aforementioned line width and distance between lines.

In the present invention, as a material of the conductive heating line, metal having excellent thermal conductivity may be used. Further, a resistivity value of the conductive heating line material may be 1 microOhm cm or more to 200 microOhm cm or less. As a detailed example of the conductive heating line material, copper, silver, carbon nanotube (CNT), and the like may be used and silver is most preferred. The conductive heating line material may be used in a particle form. In the present invention, as the conductive heating line material, copper particles that are coated with silver may also be used.

In the present invention, when the conductive heating lines are prepared by using a printing process using a paste, the paste may further comprise an organic binder in addition to the aforementioned conductive heating line material in order to facilitate the printing process. The organic binder may have volatility during a firing process. The organic binder may comprise a polyacrylic resin, a polyurethane resin, a polyester resin, a polyolefin resin, a polycarbonate resin, a cellulose resin, a polyimide resin, a polyethylene naphthalate resin, a modified epoxy, and the like, but is not limited thereto only.

In order to improve adhesion of the paste to the transparent substrate such as glass, the paste may further comprise a glass frit. The glass frit may be selected from a commercial product, but it is preferable to use an eco-friendly glass frit without a lead content. In this case, the used glass frit may have an average aperture of 2 μm or less and may have a maximum aperture of 50 μm or less.

If necessary, a solvent may be further added to the paste. The solvent comprises butyl carbitol acetate, carbitol acetate, cyclohexanon, cellosolve acetate, terpineol, and the like, but the scope of the present invention is not limited to the examples.

In the present invention, when the paste comprising the conductive heating line material, the organic binder, the glass frit, and the solvent is used, weight ratios of the respective ingredients may be 50 to 90 wt % of the conductive heating line material, 1 to 20 wt % of the organic binder, 0.1 to 10 wt % of the glass frit, and 1 to 20 wt % of the solvent.

In the present invention, in the case of using the aforementioned paste, a heating line having conductivity is formed through a firing process after printing the paste. In this case, a firing temperature is not particularly limited, but may be 500 to 800° C. and 600 to 700° C. When the transparent substrate forming the heating line pattern is glass, if necessary, the glass may be molded so as to be suitable for an intended use such as a building, a vehicle, or the like during the firing process. For example, when glass for a vehicle is molded in a curved surface, the paste may also be fired. Further, in the case where the plastic substrate or film is used as the transparent substrate forming the conductive heating line pattern, the firing may be performed at a relatively low temperature. For example, the firing may be performed at 50 to 350° C.

In the present invention, the conductive heating line may be formed in a pattern such as a stripe, a diamond, a square grid, a circle, a wave pattern, a grid, a 2D grid, or the like and is not limited to a predetermined shape, but the conductive heating line may be designed so as to prevent light emitted from a predetermined light source from interfering with an optical property due to diffraction and interference. That is, in order to minimize regularity of the pattern, the conductive heating line may also use a wave pattern, a sine wave pattern, a spacing pattern of a grid structure, and a pattern having irregular thicknesses of a line. If necessary, the shape of the conductive heating line pattern may be a combination of two or more patterns. In the present invention, the conductive heating line may be a straight line, but may be variously modified such as a curved line, a wave line, a zigzag line, and the like.

The conductive heating line pattern may have a boundary line shape of the figures that form a Voronoi diagram. The conductive heating line pattern may have a boundary line shape of figures configured by at least one triangle forming a Delaunay pattern. In detail, the shape of the conductive heating line pattern has a boundary line shape of the triangles forming the Delaunay pattern, a boundary line shape of figures configured by at least two triangles forming the Delaunay pattern, or a combination shape thereof.

For uniform heating and visibility of the heating element, an aperture ratio of the conductive heating line pattern may be constant in a unit area. The heating element may have a transmittance deviation of 5% or less to any circle having a diameter of 20 cm. In this case, it is possible to prevent the heating element from being locally heated. Further, in the heating element, the standard deviation of the surface temperature of the transparent substrate after heating may be within 20%.

In the present invention, after determining a desired pattern shape, the conductive heating line pattern having a thin line width and precision may be formed on the transparent substrate by using a printing method, a photolithography method, a photography method, a method using a mask, a sputtering method, an inkjet method, or the like. The pattern shape may be determined by using Voronoi diagram generators or Delaunay pattern generators and as a result, the complicated pattern shape may be easily determined. Herein, the Voronoi diagram generators and the Delaunay pattern generators refer to dots disposed so as to form the Voronoi diagram and the Delaunay pattern as described above, respectively. However, the scope of the present invention is not limited thereto and the desired pattern shape may also be determined by using other methods.

The printing method may be performed by transferring and firing a paste comprising a conductive heating line material on a transparent substrate in a desired pattern shape. The transferring method is not particularly limited, but the desired pattern may be transferred on the transparent substrate by forming the pattern shape on a pattern transfer medium such as an intaglio or a screen and using the formed pattern shape. A method of forming the pattern shape on the pattern transfer medium may use a known method in the art.

The printing method is not particularly limited and may use a printing method such as an offset printing method, a screen printing method, a gravure printing method, or the like. The offset printing method may be performed by primarily transferring an intaglio to a silicon rubber called a blanket after filling a paste in the intaglio with the engraved pattern and secondarily transferring the intaglio by bring the blanket and the transparent substrate in close contact with each other. The screen printing method may be performed by directly positioning a paste on a substrate through a hollow screen while pressing a squeeze after positioning the paste on the screen having the pattern. The gravure printing method may be performed by rolling a blanket engraved with a pattern on a roll and filling a paste in the pattern to be transferred to the transparent substrate. In the present invention, the methods may be used in combination in addition to the methods. Further, other printing methods known to those skilled in the art may also be used.

In the case of the offset printing method, since the paste is almost transferred to the transparent substrate such as glass because of a releasing property of the blanket, a separate blanket cleaning process is not required. The intaglio may be fabricated by precisely etching the glass on where a desired conductive heating line pattern is engraved and for durability, metal or diamond-like carbon (DLC) may be coated on the glass surface. The intaglio may also be fabricated by etching a metal plate. In the present invention, in order to implement a more precise conductive heating line pattern, the offset printing method may be used. For example, the offset printing method may be performed by filling the paste in the pattern of the intaglio by using a doctor blade and then performing a primary transfer by rotating the blanket, as the first step, and performing a secondary transfer on the surface of the transparent substrate by rotating the blanket as the second step.

The present invention is not limited to the above printing methods and may also use a photolithography process. For example, the photolithography process may be performed by forming a conductive heating line pattern material layer on the entire surface of a transparent substrate, forming a photoresist layer thereon, patterning the photoresist layer by a selective exposing and developing process, etching the conductive heating line pattern material layer by using the patterned photoresist layer as a mask to pattern the conductive heating line, and then, removing the photoresist layer.

The conductive heating line pattern material layer may also be formed by laminating a metal thin film such as copper, aluminum, and silver on the transparent substrate by using an adhesive layer. Further, the conductive heating line pattern material layer may also be a metal layer formed on the transparent substrate by using a sputtering or physical vapor deposition method. In this case, the conductive heating line pattern material layer may also be formed in a multilayer structure of metal having good electrical conductivity such as copper, aluminum, and silver and metal having good attachment with the substrate and dark colors such as Mo, Ni, Cr, and Ti. In this case, the thickness of the metal thin film may be 20 μm or less and 10 μm or less.

In the present invention, the photoresist layer may also be formed by using a printing process instead of the photolithography process during the photolithography process.

Further, the present invention may also use the photography method. For example, after a photographic photosensitive material comprising silver halide is coated on the transparent substrate, the pattern may also be formed by selectively exposing and developing the photosensitive material. A more detailed example is as follows. First, a negative photosensitive material is coated on a substrate to form a pattern. In this case, as the substrate, a polymer film such as PET, acetyl celluloid, and the like may be used. Herein, a polymer film member coated with the photosensitive material is called a film. The negative photosensitive material may be generally constituted by silver halide obtained by mixing a little AgI into AgBr reacting very sensitively and regularly to light. Since an image developed by photographing a general negative photosensitive material is a negative image having an opposite contrast to a subject, the photographing may be performed by using a mask having a pattern shape to be formed, preferably, an irregular pattern shape.

In order to increase conductivity of the heating line pattern formed by using the photolithography and photography processes, a plating process may be additionally performed. The plating may be performed by using an electroless plating method, a plating material may be copper or nickel, and after performing copper plating, nickel plating may be performed thereon, but the scope of the present invention is not limited thereto.

Further, the present invention may also use the method using a mask. For example, after a mask having a heating line pattern is disposed near a substrate, the heating line pattern material may also be patterned on the substrate by using a deposition method. In this case, the deposition method may also use a heat deposition method due to heat or an electron beam, a physical vapor deposition (PVD) method such as sputter, and a chemical vapor deposition (CVD) method using an organometal material.

The heating element according to the present invention may further comprise a busbar and a power supply unit connected to the busbar. The busbar and the power supply unit may be formed by using a known method in the art. For example, the busbar may also be formed simultaneously with the formation of the conductive heating line and may also be formed by using the same or different printing method after forming the conductive heating line. For example, after the conductive heating line is formed by using an offset printing method, the busbar may be formed through the screen printing. In this case, a thickness of the busbar may be 1 to 100 μm and 10 to 50 μm. When the thickness thereof is less than 1 pm, contact resistance between the conductive heating line and the busbar increases, and thus local heating may occur at a contact portion and when the thickness exceeds 100 μm, costs of electrode materials may increase. The connection between the busbar and the power supply unit may be performed through soldering and physical contact with a structure having good conductive heating.

In order to cover the conductive heating line and the busbar, a black pattern may be formed. The black pattern may be printed by using a paste containing cobalt oxide. In this case, as the printing method, the screen printing is preferably used and the thickness is preferably 10 to 100 μm. The conductive heating line and the busbar may also be formed before or after forming the black pattern.

The heating element according to the present invention may comprise an additional transparent substrate provided on the surface with the conductive heating line of the transparent substrate. As described above, the additional transparent substrate may be glass, a plastic substrate, or a plastic film. An adhesive film may be interposed between the conductive heating line and the additional transparent substrate during the attachment of the additional transparent substrate. A temperature and a pressure may be controlled during the adhering process.

As a material of the adhesive film, any material having adhesion and becoming transparent after adhering may be used. For example, the material may comprise a PVB film, an EVA film, a PU film, or the like, but is not limited to these examples. The adhesive film is not particularly limited, but the thickness thereof may be 100 to 800 μm.

In one detailed exemplary embodiment, a primary adhering is performed by inserting the adhesive film between the transparent substrate with the conductive heating lines and the additional transparent substrate and removing air by putting them into a vacuum bag and increasing a temperature while reducing pressure or increasing a temperature using a hot roll. In this case, a pressure, a temperature, and a time vary according to a kind of adhesive film, but generally, a temperature from room temperature to 100° C. may be gradually increased under a pressure of 300 to 700 torr. In this case, generally, the time may be within 1 hour. A laminated body pre-adhered after finishing the primary adhering is subjected to a secondary adhering through an autoclaving process in which a temperature is increased while applying pressure in an autoclave. The secondary adhering varies according to a kind of adhesive film, but may be performed at a pressure of 140 bar or more and a temperature of about 130 to 150° C. for 1 hour to 3 hours or about 2 hours and then, slow cooling may be performed.

In another detailed exemplary embodiment, unlike the aforementioned 2-step adhering process, an adhering method in one step may be used by using vacuum laminator equipment. While the temperature is increased up to 80 to 150° C. stepwise and slow cooling is performed, the adhering may be performed by reducing the pressure (to 5 mbar) up to 100° C. and thereafter, increasing the pressure (to 1,000 mbar).

The heating element according to the present invention may be connected to the power supply for heating and in this case, the heating value may be 100 to 700 W per m² and 200 to 300 W per m². Since the heating element according to the present invention has excellent heating performance even at low voltage, for example, 30 V or less or 20 V or less, the heating element may be usefully used even in vehicles or the like. The resistance in the heating element may be 5 ohm/square or less, 1 ohm/square or less, and 0.5 ohm/square or less.

The heating element according to the present invention may have a shape forming a curved surface.

In the heating element according to the present invention, an aperture ratio of the conductive heating line pattern, that is, a ratio of a region of glass which is not covered by the pattern may be 70% or more. The heating element according to the present invention has an excellent heating characteristic capable of increasing the temperature while the aperture ratio is 70% or more and a temperature deviation is maintained at 10% or less within 5 minutes after the heating operation.

The heating element according to the present invention may be applied to various transport vehicles such as a car, a ship, a train, a high-speed train, an airplane, and the like, or glass used in a house or other buildings. Particularly, since the heating element according to the present invention may have an excellent heating characteristic even at low voltage, minimize the side effects due to the diffraction and interference of the light source after sunset, and be invisibly formed due to the line width as described above, the heating element may also be applied to a windscreen for a transport vehicle such as a car unlike the related art.

### Mode for Invention

Hereinafter, the present invention will be described in more detail with reference to Examples. However, the following Examples just exemplify the present invention and the scope of the present invention is not limited to the following Examples.

### EXAMPLE

### Example 1

Conductive heating lines having a line width of 10 μm, a line height of 10 μm, and a distance of 300 μm between lines were formed on a transparent substrate by using an etching technology. After forming an electrode capable of applying voltage on a surface with the conductive heating lines, a polyvinyl butadiene (PVB) film was adhered.

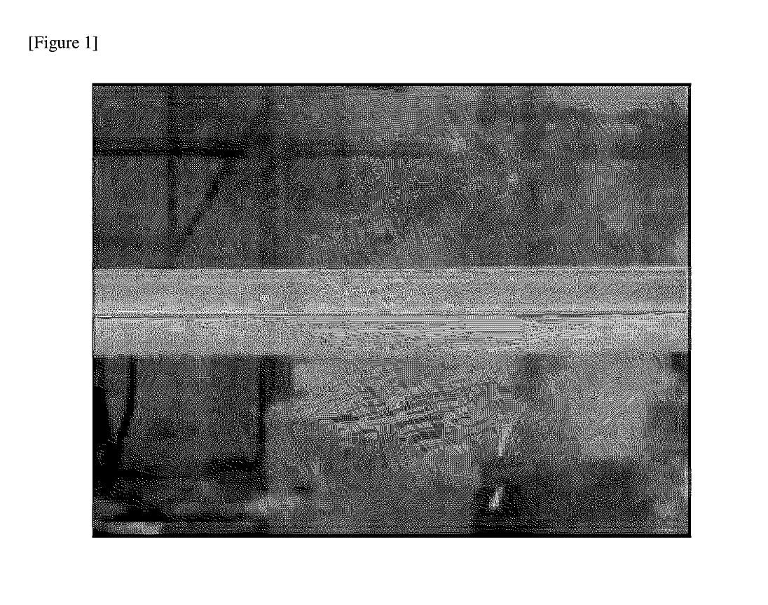

A transformed degree was checked through the aforementioned perspective transformation test and was also observed with the naked eye. Even when the heating value was 600 W/m², as shown in FIG. 1, distortion of a view did not occur and there was no displacement difference in the diameter of the circle projected on the screen according to the perspective transformation test.

### Example 2

Conductive heating lines having a line width of 3 a line height of 500 nm, and a distance of 120 μm between lines were formed on a transparent substrate by using an etching technology. After forming an electrode capable of applying voltage on a surface with the conductive heating lines, a polyvinyl butadiene (PVB) film was adhered.

A transformed degree was checked through the aforementioned perspective transformation test and was also observed with the naked eye. Even when the heating value was 750 W/m², as shown in FIG. 1, distortion of a view did not occur and there was no displacement difference in the diameter of the circle projected on the screen according to the perspective transformation test. Further, a property of covering a pattern was more excellent while the line width was decreased compared to Example 1.

### Comparative Example 1

Conductive heating lines having a line width of 10 μm, a line height of 10 μm, and a distance of 2 mm between lines were formed on a transparent substrate by using an etching technology. After forming an electrode capable of applying voltage on a surface with the conductive heating lines, a polyvinyl butadiene (PVB) film was adhered.

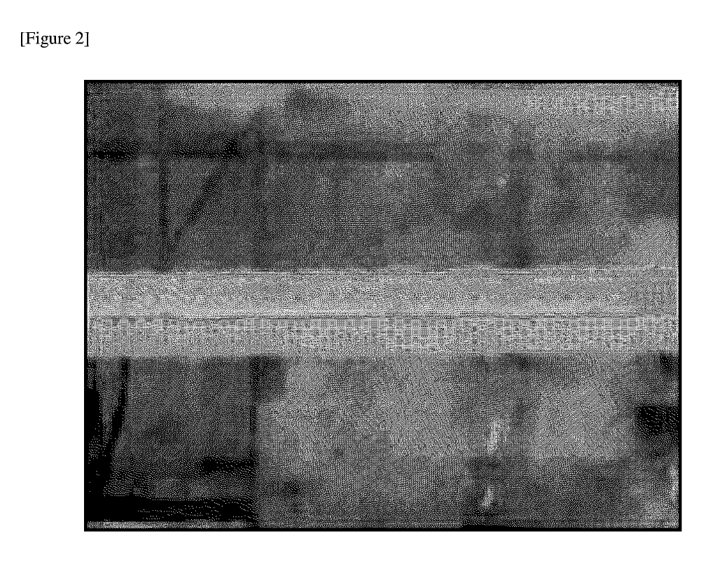

As a result of the perspective transformation test, when the heating value was 50 W/m², a displacement difference of 9% was exhibited and the distortion of a view was not recognized with the naked eye. However, when the heating value is 300 W/m², the displacement difference in the diameter of the circle projected on the screen according to the perspective transformation test was observed as 20% and when the heating value is 750 W/m², the displacement difference in the diameter of the circle projected on the screen according to the perspective transformation test was observed as 57% (7 mm→11 mm) and distortion of a view occurred as shown in FIG. 2.

### Comparative Example 2

A conductive heating line having a line width of 22 μm, a line height of 20 μm, and a distance of 2 mm between lines was formed on a transparent substrate by using an etching technology. After forming an electrode capable of applying voltage on a surface with the conductive heating lines, a polyvinyl butadiene (PVB) film was adhered.

As a result of the perspective transformation test, when the heating value was 100 W/m², the displacement difference of 7% was exhibited and the distortion of a view was not recognized with the naked eye. However, when the heating value is 300 W/m², the displacement difference in the diameter of the circle projected on the screen according to the perspective transformation test was observed as 18% and when the heating value is 600 W/m², the displacement difference in the diameter of the circle projected on the screen according to the perspective transformation test was observed as 28% (7 mm→9mm) and the distortion of a view occurred as shown in FIG. 2.

As described above, in the present invention, it is possible to provide excellent optical characteristics without optical interference without obstructing a field of vision even when the conductive heating line is made of an opaque material such as metal and to prevent the distortion of a view in which an image shimmers due to local heating around the conductive heating line even when the heating value is 200 W/m² or more, by controlling the line width and the distance between lines of the conductive heating lines of the heating element.

1. A heating element comprising:
a transparent substrate; and
conductive heating lines provided on the transparent substrate,
wherein a line width of the conductive heating line is 10 μm or less and a distance between the conductive heating lines is 500 μm or less.

2. The heating element of claim 1, wherein a transformed degree by a perspective transformation test of the heating element is 10% or less when a heating value is 200 to 1,000 W/m².

3. The heating element of claim 1, wherein a transformed degree by a perspective transformation test of the heating element is 5% or less when a heating value is 200 to 1,000 W/m².

4. The heating element of claim 1, wherein a distance between the conductive heating lines is 300 μm or less.

5. The heating element of claim 1, wherein a line width of the conductive heating line is 8 μm or less.

6. The heating element of claim 1, wherein a line width of the conductive heating line is 8 μm or less and a distance between the lines is 300 μm or less.

7. The heating element of claim 1, wherein a line height the conductive heating line is 20 μm or less.

8. The heating element of claim 1, wherein the heating element is for heating of 200 W/m² or more.

9. The heating element of claim 1, wherein the transparent substrate is glass, a plastic substrate or a plastic film.

10. The heating element of claim 1, further comprising:
an additional transparent substrate provided on a surface with the conductive heating lines.

11. The heating element of claim 10, wherein the additional transparent substrate is glass, a plastic substrate or a plastic film.

12. The heating element of claim 1, wherein the heating element is for a vehicle or a building.

13. A method of manufacturing a heating element, comprising:
forming conductive heating lines having a line width of 10 μm or less and a distance of 500 μm or less between the lines on a transparent substrate.

14. The method of claim 13, further comprising:
adhering an additional transparent substrate on the surface with the conductive heating lines.

15. The heating element of claim 2, wherein the heating element is for a vehicle or a building.
